(19) United States
(12) Patent Application Publication
(10) Pub. No.: US 2002/0096989 A1
(43) Pub. Date: Jul. 25, 2002

(54) Display device and cathode ray tube

(75) Inventor: Heidrun Steinhauser, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/995,468

(22) Filed: Nov. 28, 2001

(30) Foreign Application Priority Data
Nov. 29, 2000 (EP) 00204238.0

(51) Int. Cl. H01J 29/51

(52) U.S. Cl. 313/414; 313/412

(57) ABSTRACT

A display device comprising a deflection unit and a cathode ray tube having an in-line electron gun. The electron gun comprises a main lens portion having means for generating a main lens field and a quadrupole field. During operation, the intensity of said fields is dynamically varied. The electron gun comprises a prefocusing lens portion having means for generating a prefocusing lens field and a further quadrupole field. During operation, the intensity of said fields is controlled in such a way that, in operation, the first quadrupole field and the main lens cause a dynamically converging effect in a direction parallel to the in-line plane, and the second quadrupole field and the prefocusing lens cause a dynamically diverging effect in a direction parallel to the in-line plane, the dynamically converging effect compensating the dynamically diverging effect in the direction parallel to the in-line plane. By virtue thereof, an improved picture reproduction can be obtained.

The invention relates to a display device as defined in the precharacterizing part of claim 1.

The invention also relates to a cathode ray tube which is suitable for use in a display device.

Such a display device is used in, inter alia, television displays and computer monitors.

A display device of the kind mentioned in the opening paragraph, provided with a deflection unit and a cathode ray tube having an in-line electron gun, is known from EP-A 509590. The electron gun comprises a main lens portion having means for generating a main lens field and a first quadrupole field. During operation, the intensity of said fields is dynamically varied. This allows astigmatism and focusing of the electron beams as a function of the deflection to be controlled so that astigmatism caused by the deflection is at least partly compensated and the electron beams are substantially in focus throughout the display screen. The electron gun comprises a pre-focusing lens portion having means for generating a prefocusing lens field and a further quadrupole field. In the known device, the intensity of said fields is controlled during operation so that a dynamically cylindrical lens is formed in the prefocusing lens portion for reducing the beam angle in the vertical direction.

In display devices according to the state of the art having a real flat surface on the outer side of the display screen, disturbing pictures may occur in particular at the edges of the display screen. For example, characters may become less distinct as they are reproduced close together in the corners of the display screen.

It is, inter alia, an object of the invention to provide a cathode ray tube having an improved picture quality.

This object is achieved by the display device according to the invention as defined in claim 1. The invention is, inter alia, based on the recognition that, particularly in cathode ray tubes with a real flat screen and a smaller neck length, the electron beams are projected more on an inner surface of the screen and undergo an increased optical path length difference between the center and the corner positions.

In the known display device, an increasing positive effect of a prefocusing lens and an increasing diverging effect of the second quadrupole field, as well as an increasing positive effect of the first quadrupole field and a decreasing positive effect of the main lens compensate each other in the horizontal direction. In the display device according to the invention, the increasing positive effect of the prefocusing lens and the increasing diverging effect of the second quadrupole field have a net negative effect, and the increasing positive effect of the first quadrupole field and the decreasing positive effect of the main lens have a net positive effect, the net negative effect and the net positive effect compensating each other.

In a known display device, an increasing positive effect of the prefocusing lens and a converging effect of the second quadrupole field reduce the beam angle of the electron beam entering the main lens in a vertical direction, while an increasing negative effect of the first quadrupole field and a decreasing positive effect of the main lens maintain focus of the electron beam in the corners. In the display device according to the invention, the effects in the vertical direction are the same, but stronger than in the known display device.

In this patent application, horizontal is understood to be a direction parallel to the in-line plane and vertical is understood to be a direction transversely to the in-line plane. Furthermore, a quadrupole field modulates the shape of an electron beam. It reduces the size of the electron beam in one direction and increases the size of an electron beam in a direction perpendicularly to said direction. A prefocusing field influences, that is increases or reduces, the size of an electron beam in all directions to an approximately equal degree. The spot uniformity can be improved when the spot in the corner can be decreased in the horizontal direction and increased in the vertical direction. This increases the discrepancy between optimum beams entering the main lens intended for the center of the screen or intended for the corners of the screen. In the horizontal direction, the beam angle has to be reduced for a beam intended for the center in order to reduce the effect of spherical aberration. In the vertical direction, the beam angle has to be enlarged in the center to take full advantage of the main lens quality. In the display device according to the invention, a combination of the prefocusing lens and the second quadrupole field reduces the beam angle in the horizontal direction for the electron beam entering the main lens intended for the center for compensating the dynamically converging effect of the first quadrupole field and the main lens. Because of the large reduction of the beam in the vertical direction, the spherical aberration in the corners is reduced and the focus in the vertical direction is shifted to the display screen. Because of the divergent effect on an electron beam intended for the corners, the horizontal focal point is shifted behind the display screen. Therefore, in a horizontal direction, the first quadrupole field and the main lens should have a net converging effect as compared to the neutral effect in the horizontal direction in conventional display devices. Since the horizontal beam angle in the corners is larger than in the center, an improved overall horizontal beam spot performance is obtained.

Furthermore, the net converging effect of the first quadrupole field and the main lens provides a more gradual potential course which results in an improved main lens system. An advantage of this effect of the first quadrupole field is that a lower dynamic range of the first quadrupole field can be used. This results in a cost reduction of the semiconductor devices required to provide said dynamic range of the first quadrupole field, because of the lower operating voltages of these semiconductor devices.

Advantageous embodiments of the display device according to the invention are claimed in the dependent claims.

These and other aspects of the invention are apparent from and will be elucidated with reference to the embodiments described hereinafter.

In the drawings:

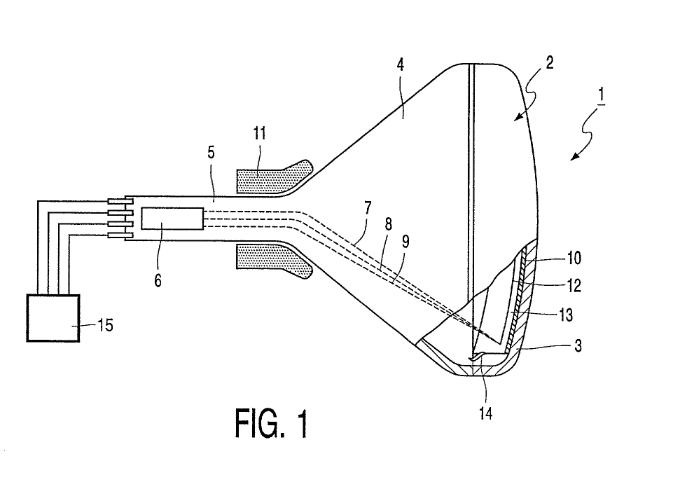

FIG. 1 is a sectional view of a display device,

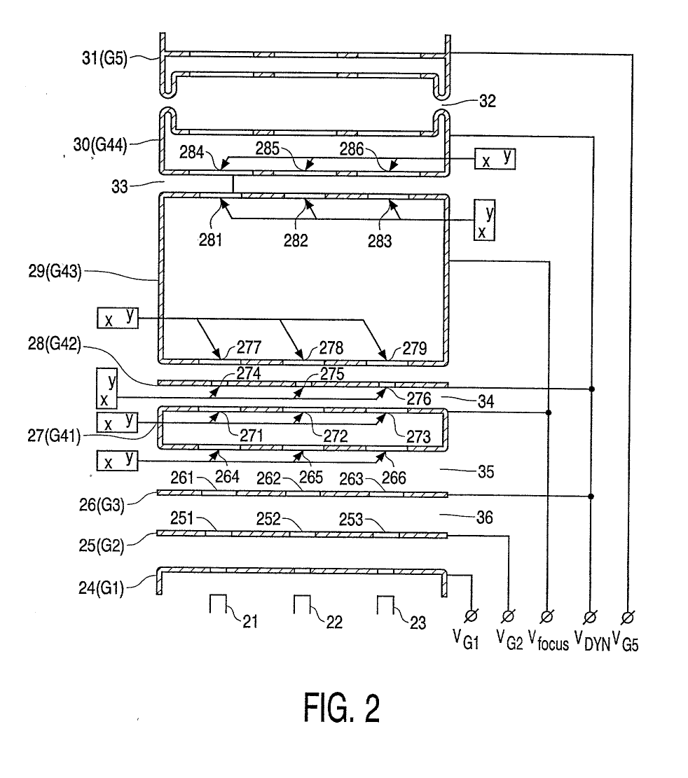

FIG. 2 is a sectional view of an electron gun which can be suitably used in a cathode ray tube for a display device

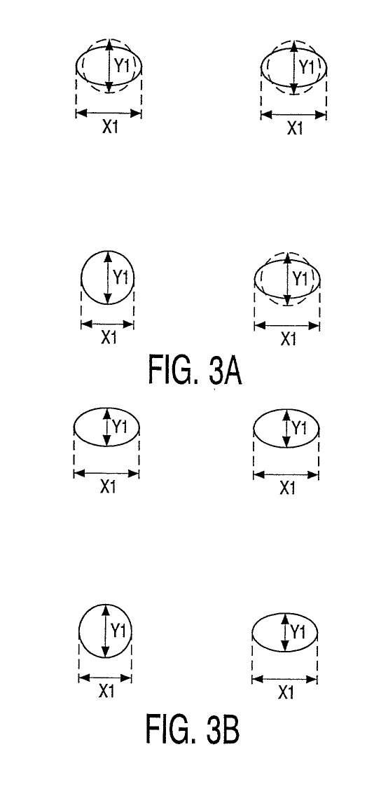

FIGS. 3a and 3b. illustrate the effect of the invention on the beam section.

The display device comprises a cathode ray tube, in this example a color display tube 1, having an evacuated envelope 2 which consists of a display window 3, a cone portion 4 and a neck 5. The neck 5 accomodates an electron gun 6 for generating three electron beams 7, 8 and 9 which extend in one plane, the in-line plane which in this case is the plane of the drawing. A display screen 10 is provided on the inner side of the display window. Said display screen 10 comprises a large number of phosphor elements luminescing in red, green and blue. On their way to the display screen 10, the electron beams 7, 8 and 9 are deflected across the display screen 10 by means of a deflection unit 11 and pass through a color selection electrode 12 which is arranged in front of the display window 3 and comprises a thin plate with apertures 13. The color selection electrode is suspended in the display window by suspension means 14. The three electron beams 7, 8 and 9 pass through the apertures 13 of the color selection electrode at a small angle to each other. Consequently, each electron beam impinges on phosphor elements of only one color. The display device further comprises means 15 for generating voltages which, in operation, are applied to components of the electron gun.

FIG. 2 is a sectional view of an electron gun which is suitable for use in a cathode ray tube according to the invention. The electron gun 6 comprises three cathodes 21, 22 and 23. It further comprises a first common electrode 24 (G₁), a second common electrode 25 (G₂), a third common electrode 26 (G₃), a fourth common electrode 27 (G₄₁), a fifth common electrode 28 (G₄₂), a sixth common electrode 29 (G₄₃), a seventh common electrode 30 (G₄₄) and an eighth common electrode 31 (G₅) Electrodes 31 (G₅) and 30 (G₄₄) form an electron-optical element in the main lens portion of the electron gun for generating a main lens field which is formed, in operation, between said electrodes 30 and 31 in space 32. Alternatively, the main lens portion may be formed by a distributed composed main lens field. (DCFL). Electrodes 30 (G₄₄) and 29 (G₄₃) form an electron-optical element in the main lens portion of the electron gun for generating a first quadrupole field which, in operation, is generated between the electrodes 30 and 29 in space 33. The electrodes have connections for applying electric voltages. The display device comprises leads, not shown, for applying electric voltages which are generated in the means 15. The cathodes and the electrodes 24 and 25 form the so-called triode portion of the electron gun. Electrodes 25 (G₂) and 26 (G₃) form an electron-optical element in the prefocusing portion of the electron gun for generating a first prefocusing field approximately in space 36. Electrodes 27 (G₃₂) and 26 (G₃₁) form an electron-optical element in the prefocusing portion of the electron gun for generating a third quadrupole field in space 35 between the electrodes 26 and 27. Electrodes 27 (G₄₁), 28 (G₄₂) and 29(G₄₃) form an electron-optical element in the prefocusing portion of the electron gun for generating a second quadrupole field in space 34. All electrodes have apertures for transmitting the electron beams. In this example, apertures 281, 282 and 283 are rectangular as are apertures 284,285 and 286. This is diagrammatically shown by means of rectangles beside the apertures. Apertures 271, 272 and 273, apertures 274, 275 and 276, and apertures 277, 278 and 279 are also rectangularly shaped as is diagrammatically shown beside said apertures. Apertures 264, 265 and 266 are also rectangularly shaped as is diagrammatically shown by means of a rectangle beside the apertures. In operation, a dynamic potential V_{dyn} is applied to electrodes 30 (G₄₄), 28 (G₄₂) and 26(G₃). Said potential V_{dyn} typically exhibits a dynamic variation of the order of several hundred volts to several kV above or below a value of approximately 6 to 8 kV. In operation, a potential V_{G5} of approximately 25 kV to 30 kV is applied to electrode 31 (G₅), also termed anode. The electron beams are deflected across the display screen by deflection unit 11. The electromagnetic deflection field also has a focusing effect and causes astigmatism. Said effects are governed by the deflection angle of the electrons. The dynamic voltage V_{dyn} varies as a function of the deflection angle of the electron beams. In operation, an approximately first quadrupole field is generated between the electrodes 29 (G₄₃) and 30(G₄₄). The apertures are selected so that the effect of a dynamic variation of the potential applied to electrode 30 (G₄₄) on the beam size in the horizontal direction and brought about in the main lens is of opposite sign, and the effect on the beam size in the horizontal direction brought about in the first quadrupole field causes a net positive dynamic lens action in the horizontal direction. In the vertical direction, the lens actions of the main lens field and the first quadrupole field intensify each other.

Particularly in the case of color display tubes having a substantial (for example 110° or larger) angle of deflection and a real flat display screen, disturbing effects may occur because the spot is not uniform across the display screen.

In this example, the apertures 251, 252 and 253 in electrode 25 (G₂) are round, as are the apertures 264, 265 and 266 in electrode 26 (G₃). In operation, a rotationally symmetrical prefocusing lens is formed between the electrodes 25 and 26, which lens varies just as much in the horizontal (x) direction as in the vertical (y) direction as a function of a dynamic potential V′_{dyn} applied to electrode 26 (G₃). Furthermore, a second approximately quadrupole field is generated between the electrodes 27 (G₄₁), 28 (G₄₂) and 29(G₄₂) and, preferably, a third approximately quadrupole field is generated between the electrodes 26(G₃) and 27 (G₄₁). The apertures are selected so that the effect of a dynamic variation of the potential applied to electrode 26(G₃) and 28 (G₄₂) on the beam size in the horizontal direction and brought about in the prefocusing lens is of opposite sign, and the effect on the beam size in the horizontal direction brought about in the second and third quadrupole fields causes a net negative dynamic lens action in the horizontal direction, while the net negative lens dynamic lens action substantially cancels the net positive dynamic lens action of the first quadrupole field and the main lens in the horizontal direction. In the vertical direction, the lens actions of the prefocusing lens and the second and third quadrupole fields intensify each other.

Tables 1 and 2 show half the beam angle in the x-direction (x) and in the y-direction (y) of the electron beams on the display screen, as a function of the potential V′_{dyn} applied to electrode 26 (G₃₁) and 28(G₄₂) at beam currents of 0.5 mA and 2.0 mA, respectively. In this example, the following values apply.

diameter of apertures in electrode 25 (G₂): 0.52 mm

diameter of apertures in electrode 26 (G₃): 0.8 mm

apertures 264, 265 and 266: 4 (x)×0.9 (y)mm

apertures 271, 272 and 273: 4.5 (x)×1.8(y)mm

apertures 274, 275 and 276: 1.8 (x)×4.5(y)mm

apertures 277, 278 and 279: 4.5 (x)×1.8(y)mm

apertures 281, 282 and 283: 2.95 (x)×7.0(y)mm

apertures 284, 285 and 286: 4.8 (x)×2.95(y)mm

where the potential V_{G2} applied to electrode 25 (G₂) is approximately 700 Volts and the potential V_{foc} applied to electrodes 26(G₃) and 29 (G₄₃) is approximately 8400 Volts. Table 1, half the beam angle in the x and y-directions as a function of the dynamic potential V′_{dyn} at a beam current of 0.5 mA. V′_{dyn} (Volt) Half the beam angle (mrad) at 0.5 mA

Half the beam angle (mrad) at 0.5 mA

| V′_{dyn} (Volt) | | | X | Y |
|---|---|---|---|---|
| 5900 | (0 | V) | 8 | 23 |
| 6400 | (500 | V) | 18 | 11 |
| 6900 | (1000 | V) | 27 | 4 |

Table 2, half the beam angle in the x and y-directions as a function of the dynamic potential V′_{dyn} at a beam current of 2.0 mA. V′_{dyn} (Volt) Half the beam angle (mrad) at 2.0 mA

Half the beam angle (mrad) at 2.0 mA

| V′_{dyn} (Volt) | | | X | Y |
|---|---|---|---|---|
| 5900 | (0 | V) | 19 | 54 |
| 6400 | (500 | V) | 37 | 33 |
| 6900 | (1000 | V) | 55 | 18 |

The beam section in a direction (in this example the x or y-direction) on the display screen is governed by the beam angle in said direction in the following manner: the beam angle is the angle (α) at which the electron beam enters the main lens. For a main lens it holds that the Helmholtz-Lagrange product (HL) is constant in a first-order approximation, which product complies with the equation

$$HL = \frac{α}{2} * B * \sqrt{V}$$

wherein B represents the beam section in the direction in question and V represents the voltage applied to the anode. The beam section increases as the beam angle decreases. The beam angle and, hence, the beam section in the vertical (y)-direction as well as the beam angle and, hence, the beam section in the horizontal (x)- direction can be varied substantially, as shown in Table 1, by varying the dynamic potential V′_{dyn} applied to electrodes 26 (G₃), 28(G₄₂) and 30(G₄₄).

FIG. 3a shows the beam shape at the end of the long axis (A) and in the center of the screen (B) in known tubes comprising a DAF-electron gun. The beam section in the x-direction x₁ increases slightly towards the edge of the screen, in the y-direction the beam section y₁ decreases substantially and a haze appears around the spot, shown as a dotted line in FIG. 3a.

FIG. 3b shows the effect of the invention. By virtue thereof, the haze can be precluded.

Within the scope of the invention, many variations are possible to those skilled in the art, for example,

the quadrupole fields are generated between two electrodes having quadrangular apertures. The apertures may be alternatively oval, elongated or polygonal.

A quadrupole field may be generated in a different manner, for example, by raised, oppositely located edges at apertures for transmitting electron beams.

Viewed in the direction of travel of the electron beams, the quadrupole field may be located, in operation, in front of or behind the main lens field or it may be integrated therein.

It is advantageous when the means for generating the prefocusing field and the quadrupole field are constructed in such a way that it can be excited with only one dynamic voltage, as is the case in the example stated above. In this example, the dynamic voltage is applied to the common electrode G₃₁.

In this example, the electrodes 27 (G₄₁), 28(G₄₂) and the electrode 29 (G₄₃) generate the second quadrupole field and electrodes 26(G₃) and 27(G₄₁) generate the third quadrupole field.

In order to improve the second and the third quadrupole field, it is also possible to exchange the plate electrode 26 (G₃) with a bus electrode 28 having apertures 261, 262, 263 and apertures 261′, 262′, 263′.

It may also be possible to omit the electrode 28(G₄₂) and generate only a second quadrupole field by the electrodes 27(G₄₁) and 29(G₄₃) which may cause some beam interception at the electrodes 27 (G₄₁) and 29(G₄₃). Furthermore, in order to enhance the second quadrupole field, it is possible to provide the apertures 271,272,273 and 277,278,279 in electrodes 27 en 29 with raised, oppositely located edges.

1. A display device comprising a cathode ray tube and a deflection unit, the cathode ray tube including an in-line electron gun, a main lens portion with means for generating a main lens field and a first quadrupole field, means for dynamically varying the strength of the main lens field and the first quadrupole field,
a pre-focusing lens portion with means for generating a pre-focusing lens field and a second quadrupole field and means for dynamically varying the strength of the pre-focusing lens field and the second quadrupole field,
characterized in that, in operation, the first quadrupole field and the main lens cause a dynamically converging effect in a direction parallel to the in-line plane, and the second quadrupole field and the prefocusing lens cause a dynamically diverging effect in a direction parallel to the in-line plane, the dynamically converging effect compensating the dynamically diverging effect in the direction parallel to the in-line plane.

2. A display device as claimed in claim 1, characterized in that the means for generating the prefocusing field and the second quadrupole field are constructed in such a way that, in operation, only one prefocusing lens and two quadrupole fields for building up the second quadrupole field are generated in the prefocusing lens portion.

3. A display device as claimed in claim 1, characterized in that the means for dynamically varying the strength of the main lens field and the first quadrupole field and the means for dynamically varying the strength of the pre-focusing lens field and the two quadrupole fields can be excited by a single dynamic voltage .

4. A display device as claimed in claim 3, characterized in that, viewed in the direction of travel of the electron beams, the in-line electron gun comprises a first common electrode, a second common electrode, a third common electrode, a fourth electrode, a fifth electrode, a sixth electrode, and a seventh electrode, which electrodes have apertures for transmitting electron beams, and in that the display device comprises means for applying the dynamic voltage to the third, the fifth and the seventh electrode.

5. A cathode ray tube for use in a display device as claimed in any one of the preceding claims.
